(19) United States
(12) Patent Application Publication
(10) Pub. No.: US 2004/0182216 A1
(43) Pub. Date: Sep. 23, 2004

(54) Coating for a chainsaw chain

(75) Inventor: Robert L. Morrison, Shreveport, LA (US)

Correspondence Address: Robert F. Bodi, Pearne & Gordon LLP, Suite 1200, 526 Superior Avenue East, Cleveland, OH, 44114-1484, US

(73) Assignee: Electrolux Professional Outdoor Products, Inc., Cleveland, OH

(21) Appl. No.: 10/631,901

(22) Filed: Jul. 31, 2003

Related U.S. Application Data
(60) Provisional application No. 60/400,354, filed on Jul. 31, 2002.

(51) Int. Cl. B26D 1/46

(52) U.S. Cl. 83/661

(57) ABSTRACT

An extended-wear chain for a chainsaw, for example, with the chain having a coating that improves one or more wear characteristics of the chain. The coating preferrably includes one or more of titanium, zirconium, a titanium compound, or a zirconium compound. The coating can be deposited by using a physical vapor deposition process, for example.

### CROSS-REFERENCES TO RELATED APPLICATIONS

This application claims the benefit of provisional application serial No. 60/400,354 incorporated herein by reference.

The invention, in general, relates to the process of coating chain saw chains and links with a coating, and the resulting chain saw chains; and in particular, to coating chain saw chains and links with titanium, and/or zirconium, and/or alloys of titanium and/or zirconium, and the resulting chain saw chains.

### BACKGROUND OF THE INVENTION

Chainsaws are used for cutting tree limbs and entire trees, such as for harvesting trees, for example, in forestry work, or for landscaping purposes, such as pruning and thinning trees. Chainsaws have also been used for additional purposes such as digging, for example. Thus, chainsaws are used industrially and residentially.

Chainsaws typically use high-speed rotating chains running on a chain guide to perform the cutting function. Typically, chainsaw chains have a number of components, including cutters (left and right handed), tie straps, pre-set tie straps, drive links, and depth gages. The cutters typically perform most of the cutting functions of the chain saw chain. Accordingly, the cutters are heavy wear items due to the fact that they are used to perform the actual cutting of wood. Consequently, cutters must be periodically sharpened, and chains replaced, due to the cutter wear. Reducing the amount of sharpening and increasing chain life is desirable for economic and efficiency improvements.

Further, other portions of the chain are also subject to wear. For example, some portions of the chain contact a drive gear used to drive the chain. Additional portions of the chain may also contact the guide bar, or other mechanical parts of the chain saw, leading to possible additional wear areas.

In addition, new chains typically must undergo a “break in” function, wherein the new chain usually stretches and must be adjusted (i.e., tightened) periodically after initial use until the chain has reached a plateau, after which tightening is necessary less often. Reducing this “break in” period and/or reducing the total stretching of the chain is beneficial, because it reduces the costs of adjustment, increases saw availability, and reduces the risk that a chain is thrown off its tracks due to stretching.

Finally, chainsaw chain cutters are sometimes coated with chrome to improve their wear characteristics, such as improved wear and durability. However, chrome and/or the chrome plating process (e.g., electroplating) can have a negative impact on the environment. Replacing chrome and/or the chrome plating process with a more environmentally friendly substitute would be further beneficial. Further, titanium and/or zirconium and their nitrides are much harder than chromium. Thus, a solution using any of those materials would also be beneficial.

### SUMMARY OF THE INVENTION

Provided is an extended wear chain comprising: a chain component (such as a cutter); and a coating on said chain component including one or more of zirconium, titanium, a zirconium compound, and a titanium compound.

Also provided is the above extended wear chain where the coating is a zirconium or titanium nitride.

Further provided is a chainsaw chain comprising: a plurality of cutters; means for connecting said plurality of cutters; and a coating on each of said plurality of cutters including one or more of zirconium, titanium, a zirconium compound, and a titanium compound.

Still further provided is a method for making an extended wear chain comprising the steps of: producing a chain or a chain component (such as a cutter); and coating said chain or chain component with one or more of zirconium, titanium, a zirconium compound, and a titanium compound.

Even further provided is a method for making an extended wear chain comprising the steps of: placing a chain or a chain component (such as a cutter) into a vacuum chamber; and coating said chain or chain component with a wear-extending substance by using a vacuum deposition process.

And additionally provided is a method for making an extended wear chainsaw chain comprising the steps of:

stamping a plurality of chain components from a raw material;

placing said plurality of chain components into a vacuum chamber; and

depositing a layer of one of titanium nitride and zirconium nitride on a surface of one or more of said plurality of chain components by using a physical vapor deposition process, wherein a metallurgical bond is formed between said surface of each of said plurality of chain components and said one of titanium nitride and zirconium nitride.

### BRIEF DESCRIPTION OF THE DRAWINGS

FIG. 1 shows a length of the typical chainsaw chain;

FIG. 2 shows the left and right cutter components of a chainsaw chain;

FIG. 3 shows a drive link component of a chainsaw chain;

FIG. 4 shows a tie strap and a pre-set tie strap component of a chainsaw chain; and

FIG. 5 shows a portion of a traditional chainsaw chain, and a golden hued portion of a chainsaw chain entirely coated with titanium nitride representing one embodiment of the invention.

### DETAILED DESCRIPTION OF THE PREFERRED EMBODIMENTS

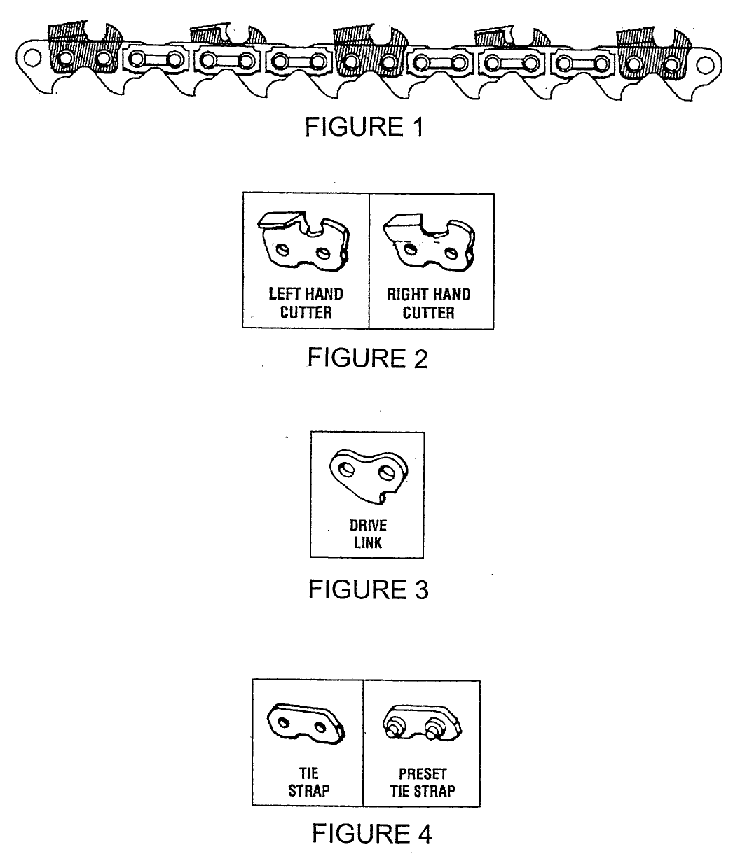

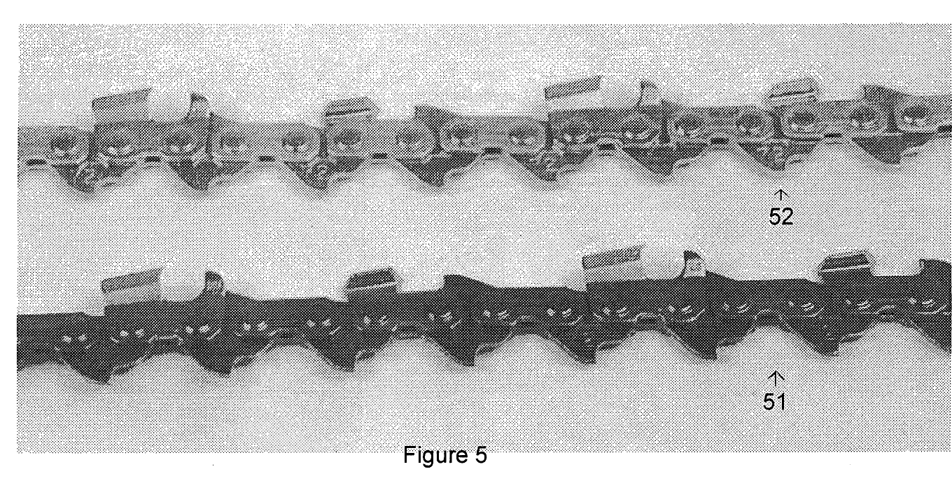

The invention, as disclosed, provides an extended wear chain, such as a chainsaw chain, as shown in FIG. 1. The wear of the chain is extended by coating the chain or some portion chain saw components, such as cutters (aka cutting links as shown in FIG. 2) and/or chain saw links (as shown in FIG. 3) and/or tie straps and pre-set tie strap components (as shown in FIG. 4) with titanium and/or zirconium and/or alloys or compounds thereof (especially nitrides). The titanium or zirconium coating may even be applied overtop a chrome coating on the chain. The titanium and/or zirconium nitride coating is to improve the life of the wear area of the chain (which is that part of the chain which contacts a gear drive), and to improve chain and cutter life in general (especially materials that come into contact with the substance to be cut). FIG. 5 shows a comparison of an uncoated chain 51 and a coated chain 52.

A vacuum deposition process, and preferably a Physical Vapor Deposition (PVD) process, is disclosed for coating one or more chainsaw chain components with titanium, zirconium, their alloys, or a titanium and/or zirconium compound, such as, preferably, titanium nitride or zirconium nitride, to create an extended wear chainsaw chain. The process can be used to replace chromium electroplating, or can be applied to parts that have already been treated by chromium electroplating, and are thus chrome plated.

PVD, a known plating/coating process, is a specific form of a vacuum deposition process where one or more materials (such as titanium, zirconium, or alloys or compounds thereof, for example) is vaporized in a vacuum chamber into individual atoms, and is transported, in atomized form, across the vacuum chamber to the substrate (the material to be coated) where it is condensed onto the surface in a thin film. There are several different PVD processes that can be used, including (but not limited to): ion plating, electron beam gun, thermal evaporation, sputtering, laser ablation, and cathodic arc, among others.

The Ion plating procedure, as known in the plating industry, is especially effective for the intended purpose. Ion plating PVD produces superior coatings adhesion. This is accomplished by bombarding the substrate with energy (such as through energized particles/ions, for example) initially, and during, deposition. The particles accelerate towards the substrate, which is typically electrically charged to an opposite charge of the ion particles. The particles of material may achieve energy levels into the hundreds of eV range or more.

These atom ions sputter off some of the substrate material, resulting in cleaning the surface of the substrate, and providing a more adherent deposit. This cleaning process continues as the substrate is coated. The film coating increases in thickness because the sputtering or cleaning rate is slower than the deposition rate, leading to a net deposit of material onto (and even into) the substrate. Resulting thicknesses may range from 0.25 to 12 microns, with most applications ranging from 1 to 5 microns. High gas pressures results in greater scattering of the vapor and a more uniform deposit on the substrate. An important variation on this process is obtained by introducing a gas such as nitrogen into the vacuum chamber to form nitride deposits (and thus resulting in titanium and/or zirconium nitrides as the primary coating material).

For the instant invention, titanium or zirconium (or both) is used as the material to be vaporized, with nitrogen added to the chamber, with the preferred result being a titanium or zirconium nitride. Titanium is preferred over zirconium because of titanium's aesthetically more pleasing results, but either metal (or a combination) can be used to provide the necessary hardness and/or wear improvements.

The coating forms a metallurgical bond to the substrate that is unlikely to flake, blister, chip or peel. The coating is typically implanted slightly into the surface layer of the substrate, leading to a strong adhesion. The coating typically conforms uniformly to the substrate, and little, if any, buildup occurs on corners.

Further, applicant has found that the titanium or zirconium nitride can be cost effectively applied in much thinner coatings than many current coatings, providing the ability to save costs, yet also provide the wear and/or durability improvements. Substrates coated with titanium nitride and/or zirconium nitride are typically not subject to hydrogen embrittlement. The PVD process preferrably results in a thin, uniform titanium or zirconium nitride coating that can remarkably improve the life of the chain and/or chain components. The titanium or zirconium nitride coating can even be applied over a chromium coated chain component, if desired.

Typical expected advantages of titanium and/or zirconium nitride include one or more of:

More environmentally friendly process;

Extreme hardness (reduce wear and stretching)

Resistant to nearly all chemicals;

Lubricity (decreases friction);

Non-stick surface (decreases friction, need to clean);

Heat resistant (longer life under heavy use); and

Non-toxic (worker friendly)

The chain saw chain components that are desired to obtain a titanium or zirconium nitride coating are put through the PVD process as described above, typically using a commercially proven process. Thus, the component to be coated becomes the substrate. Most preferrable is that the cutter components be coated, because those are the highest wear components of the chain saw chain. By coating the cutters, the wear lifetime of the cutter components can be greatly enhanced.

Additional advantage (typically at an additional cost) can be obtained by also coating other chain components, such as the tie straps, pre-set tie straps, drive links, and depth gages, with the disclosed materials. By coating one or more of these additional components, the initial wear on a new chain is reduced, resulting in less need for adjustment of newer chains being “broken in” and resulting in reducing total chain stretch and increasing chain life. By coating all chain components, the maximum wear resistance can be achieved.

The PVD process is performed preferably after the cutter (or other component or components) is stamped (or otherwise formed) during its manufacture. Entire lots of components may be processed simultaneously for increased efficiency. The chain is then assembled from the coated and perhaps additional uncoated components, and installed on a chainsaw in the normal manner.

The invention has been described hereinabove using specific examples; however, it will be understood by those skilled in the art that various alternatives may be used and equivalents may be substituted for elements or steps described herein, without deviating from the scope of the invention. Modifications may be necessary to adapt the invention to a particular situation or to particular needs without departing from the scope of the invention. It is intended that the invention not be limited to the particular implementation described herein, but that the claims be given their broadest interpretation to cover all embodiments, literal or equivalent, covered thereby.

What is claimed is:

1. An extended wear chain comprising:
a chain component; and
a coating on said component including one or more of zirconium, titanium, a zirconium compound, and a titanium compound.

2. The extended wear chain of claim 1, wherein said coating forms a metallurgical bond with said component.

3. The extended wear chain of claim 2, wherein said metallurgical bond is formed by said coating being at least slightly implanted into a surface of said component.

4. The extended wear chain of claim 1, wherein said chain is adapted for cutting a substance.

5. The extended wear chain of claim 1, wherein said coating includes zirconium nitride.

6. The extended wear chain of claim 1, wherein said coating includes titanium nitride.

7. The extended wear chain of claim 1, wherein said coating forms a layer on said component less than or equal to 12 microns thick.

8. The extended wear chain of claim 1, wherein said chain component is a cutter.

9. An extended wear chain comprising:
a chain component; and
a coating on said component including one of zirconium nitride and titanium nitride.

10. The extended wear chain of claim 1, wherein said coating forms a metallurgical bond with said component.

11. The extended wear chain of claim 10, wherein said metallurgical bond is formed by said coating being at least slightly implanted into a surface of said component.

12. The extended wear chain of claim 1, wherein said chain is adapted for cutting a substance.

13. The extended wear chain of claim 1, wherein said chain component is a cutter.

14. A chainsaw chain comprising:
a plurality of cutters;
means for connecting said plurality of cutters; and
a coating on each of said plurality of cutters including one or more of zirconium, titanium, a zirconium compound, and a titanium compound.

15. The chain of claim 14, wherein said coating forms a metallurgical bond with said cutter.

16. The chain of claim 15, wherein said metallurgical bond is formed by said coating being at least slightly implanted into a surface of said cutter.

17. The chain of claim 14, wherein said means for connecting said plurality of cutters is coated with one or more of zirconium, titanium, a zirconium compound, and a titanium compound.

18. The chain of claim 17, wherein said means for connecting said plurality of cutters is one or more of a tie strap, a pre-set tie strap, a drive link, and a depth gage.

19. A chainsaw comprising:
an extended wear chain including:
a chain component; and
a coating on said component having one or more of zirconium, titanium, a zirconium compound, and a titanium compound.

20. The chainsaw of claim 19, wherein said coating forms a metallurgical bond with said component.

21. The chainsaw of claim 20, wherein said metallurgical bond is formed by said coating being at least slightly implanted into a surface of said component.

22. The chainsaw of claim 19, wherein said component is a cutter, and further wherein a plurality of cutters are combined with a plurality of means for connecting said plurality of cutters to form said chain.

23. The chainsaw of claim 19, wherein said coating includes zirconium nitride.

24. The coated chain of claim 19, wherein said coating includes titanium nitride.

25. A method for making an extended wear chain comprising the steps of:
producing a chain or a chain component; and
coating said chain or chain component with one or more of zirconium, titanium, a zirconium compound, and a titanium compound.

26. The method of claim 25, wherein said coating is accomplished using a vacuum deposition process.

27. The method of claim 26, wherein said vacuum deposition process is a physical vapor deposition process.

28. The method of claim 27, wherein said physical vapor deposition process is one of an ion plating, an electron beam gun, a thermal evaporation, a sputtering, a laser ablation, and a cathodic arc process.

29. The method of claim 27, wherein said physical vapor deposition process is an ion plating process.

30. A method for making an extended wear chain comprising the steps of:
placing a chain or a chain component into a vacuum chamber; and
coating said chain or chain component with a wear-extending substance by using a vacuum deposition process.

31. The method of claim 30, wherein said vacuum deposition process is a physical vapor deposition process.

32. The method of claim 31, wherein said physical vapor deposition process is one of an ion plating, an electron beam gun, a thermal evaporation, a sputtering, a laser ablation, and a cathodic arc process.

33. The method of claim 31, wherein said physical vapor deposition process is an ion plating process.

34. The method of claim 30, wherein said wear-extending substance is one of zirconium, titanium, a zirconium compound, and a titanium compound.

35. The method of claim 30, wherein said wear-extending substance is one or both of zirconium nitride and titanium nitride.

36. A method for making an extended wear chainsaw chain comprising the steps of:
placing a chain cutter into a vacuum chamber; and
depositing a layer of one or both of titanium nitride and zirconium nitride on a surface of said cutter by using a physical vapor deposition process, wherein a metallurgical bond is formed between said surface of said cutter and said one or both of titanium nitride and zirconium nitride.

37. The method of claim 36, wherein said metallurgical bond is formed by said coating being at least slightly implanted into said surface of said component by said physical vapor deposition process.

38. The method of claim 36, wherein said physical vapor deposition process is an ion plating process.

39. A method for making an extended wear chainsaw chain comprising the steps of:
stamping a plurality of chain components from a raw material;
placing some portion of said plurality of chain components into a vacuum chamber; and
depositing a layer of one of titanium nitride and zirconium nitride onto surfaces of said some portion of said plurality of chain components by using a physical vapor deposition process, wherein a metallurgical bond is formed between said surfaces and said one of titanium nitride and zirconium nitride.

40. The method of claim 39, wherein said metallurgical bond is formed by said coating being at least slightly implanted into said surfaces by said physical vapor deposition process.

41. The method of claim 39, wherein said physical vapor deposition process is an ion plating process.

42. The method of claim 39, wherein at least one of said some portion of said plurality of chain components undergoing said depositing step is a cutter.

43. The method of claim 39, further comprising the step of assembling said plurality of chain components into a closed-loop chain for use in a chainsaw.
